(19) United States
(12) Patent Application Publication
(10) Pub. No.: US 2008/0082351 A1
(43) Pub. Date: Apr. 3, 2008

(54) System and Method for Providing Customized Messages Relating to Health Plan Members

(76) Inventors: Jamie P. Kelley-Hrabe, Eden Prairie, MN (US); Michael D. Tarino, St. Paul, MN (US); Laurie Schneppmueller, Cambridge, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/741,298

(22) Filed: Apr. 27, 2007

Related U.S. Application Data
(60) Provisional application No. 60/796,277, filed on Apr. 28, 2006.

(51) Int. Cl. G06Q 99/00

(52) U.S. Cl. 705/1

(57) ABSTRACT

A system and method generates customized health-related messages for one or more health plan members. The customized messages may include customized information relevant to each recipient member based on available member data, and provide the members with education, resources, knowledge and/or guidance on a member's accounts, benefits, health-related conditions and wellness potentially needed to make better-informed healthcare decisions. Messages may be provided to members and/or healthcare personnel involved in the care of plan members. To provide customized messages relating to one or more health plan members, member data is compiled to identify one or more outcomes related to the member data for each member. The outcomes are risk-stratified, and message data is generated based on the risk-stratified outcomes. The message data is configured based on the member's plan benefits, and customized messages including the configured message data are provided to the respective members and/or healthcare personnel.

### CROSS REFERENCE TO RELATED APPLICATION(S)

The present invention claims priority to U.S. Provisional Patent Application No. 60/796,277, filed on Apr. 28, 2006, entitled “Method and System for Providing a Health Statement,” which is incorporated herein by reference in its entirety.

### FIELD OF THE INVENTION

The present invention relates to a system and method for providing customized healthcare-related guidance to one or more health plan members or healthcare personnel by providing customized messages relating to management of the member's health condition(s), healthcare costs, and/or health insurance policy and associated benefits.

### BACKGROUND

Information provided to health plan members by health insurance companies generally includes a consolidated view of claim activity, account balances, benefit status, other pertinent plan information, explanations of member benefits and/or the member's medical claim data. This information is often provided in the form of periodic health statements issued to each health plan member in paper or electronic form. This data may be useful for a member in understanding their coverage, previous treatments and the costs associated with the treatments. However, in addition to providing benefit information and claim data, it is desirable to provide additional types of information to the members with the goal of more actively engaging the members in their healthcare management and enabling the members to make better informed decisions concerning their healthcare. It is also desirable to provide healthcare personnel involved in the care of plan members, such as healthcare providers and administrators, with customized information to better enable them to assist the plan members in their healthcare management. cl SUMMARY

A system and method in accordance with the present invention provide customized messages to one or more health plan members. The customized messages may include customized information relevant to each recipient member based on available member data, and are designed with the goal of providing members with the education, resources, knowledge and/or guidance they may need to make better informed healthcare decisions. For example, customized messages relating to a member's accounts, benefits, health-related conditions and wellness may better enable the member to make personally advantageous decisions concerning their healthcare management. The customized messages may also be generated to provide healthcare personnel involved in the care of plan members, such as healthcare providers and administrators, with customized information about each plan member in their care to better enable them to assist the plan members in their healthcare management.

A method for providing customized messages relating to one or more health plan members may include compiling member data to identify one or more outcomes related to the member data; risk-stratifying the one or more outcomes; providing customized messages based on at least one of the risk-stratified outcomes; configuring the customized messages based on the member's plan benefits; and providing customized messages to one or more health plan members or healthcare personnel.

Alternatively, a method for providing customized messages relating to a health plan member may include compiling member data to identify one or more outcomes related to the member data, in which the member data comprises at least member plan benefit data and at least one of member claim data, prescription claim data, laboratory claim data, member models, predictive model scores and member account balances; risk-stratifying the one or more outcomes; and providing a customized message to the member or health personnel based on at least one of the risk-stratified outcomes.

A system for providing customized messages relating to one or more health plan members may include data storage for storing member-related data; and a processor for compiling member data to identify one or more outcomes related to the member data; risk-stratifying the one or more outcomes; providing customized messages based on at least one of the risk-stratified outcomes; configuring the customized messages based on the member's plan benefits; and providing customized messages to one or more health plan members or healthcare personnel.

These and other features and advantages of the present invention will become apparent to those skilled in the art from the following detailed description, wherein it is shown and described illustrative implementations of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1A is a flowchart of an exemplary method for providing customized messages to one or more health plan members and/or healthcare personnel.

FIG. 1B is a flowchart of an alternative exemplary method for providing customized messages to one or more health plan members and/or healthcare personnel.

FIG. 2 provides an exemplary risk stratification chart listing the types of outcomes resulting from compiling member data and the outcome rank.

FIG. 3 is a chart of exemplary types of messages that may be provided to a member or healthcare personnel.

FIGS. 4A-4F depict exemplary customized messages related to a member.

FIG. 5A is a diagram of an exemplary system for providing members or healthcare personnel with customized messages.

FIG. 5B is a diagram of an exemplary system for providing a member health statement having customized messages.

### DETAILED DESCRIPTION

A system and method for providing customized messages that are customized to be relevant to members will now be described with reference to the accompanying drawings, where like elements have the same reference numbers between the various drawings.

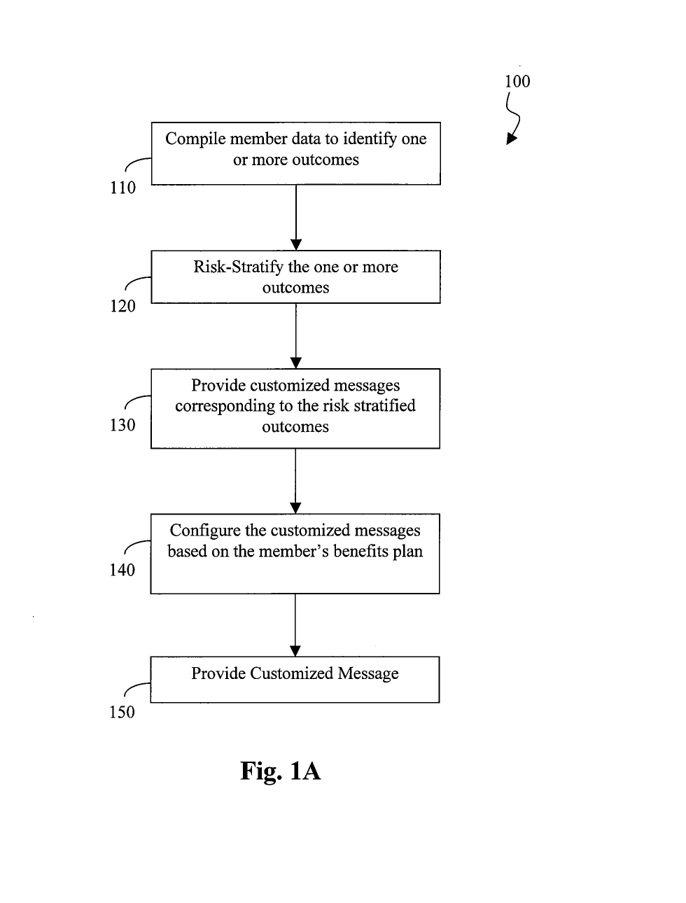

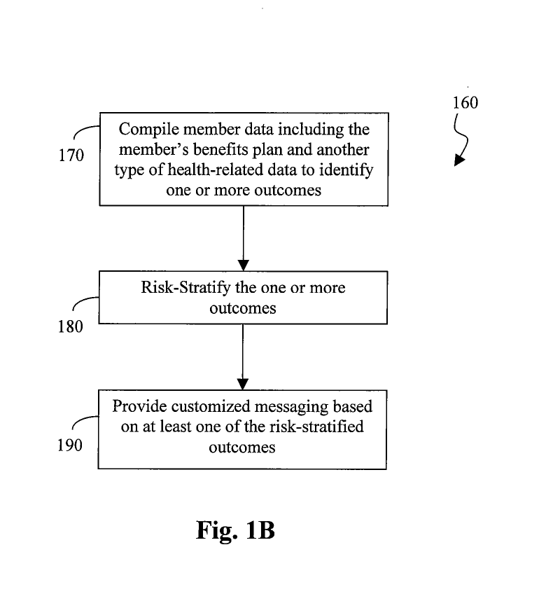

FIG. 1A is a flowchart of an exemplary method 100 for providing customized messages. The method includes compiling member data to identify one or more outcomes related to the member data (110). Member data may originate from all data sources available to the provider, e.g., health insurance company, which contains member data. Information that may be compiled includes information related to health assessments, medical claims, laboratory claims and values, prescription claims, prescription risk stratification data, predictive models, disease management, behavioral health, life coaching, nursing assistance, member surveys, call records, life stage, message response history, and insurance applications, treatment decisions and/or wellness. It will be understood that other information relevant to the member may also be compiled. The results of the compiled data are one or more outcomes, e.g., conclusions made from all of the member data analyzed. Outcomes that result from the compiled member data are risk-stratified 120, and customized messages corresponding to the risk-stratified outcomes data is provided 130 (e.g., messages are retrieved and/or generated). The provided messages are configured 140 based on the member's benefits plan, and the customized messages are provided 150, for example, to a member and/or healthcare personnel. Accordingly, the above implementation provides customized messages specific to the member in view of their benefits plan.

In accordance with method 100, customized messages including information specific to a member's benefit offerings may be generated. For example, customized messages may notify the member that they are due for a routine eye exam as part of a treatment plan for their diabetes and provide the member with contact information for one or more in-network medical professionals that provides eye exam services. Accordingly, customized messages may identify for the member aspects in their healthcare experience that may be improved, along with instructions on how to improve their healthcare experience. The customized messages are thus designed with the goal of achieving better health outcomes, realizing cost savings, and/or improving navigation of the healthcare system.

Customized messages also may be generated that do not include information related to a member's benefit offerings. For example, customized messages may notify the member that an identified behavioral condition should be addressed and inform the member of organizations, external to the provider, that may assist the member with aspects of their condition. In generating such customized messages, although the member's benefits are reviewed in accordance with method 100, specific benefit information is not included in the customized message because the member's plan does not include services for treating the identified behavioral condition. In theses instances, customized messages may be configured 140 based on the member's benefits plan, even though instructions related to utilizing the member's benefits plan are not provided.

FIG. 1B is another flowchart of an alternative exemplary method 160 for providing customized messages. Method 160 includes compiling 170 member data to identify one or more outcomes related to the member data, where member data includes at least a member's benefits plan, along with additional member data such as member claim data, prescription claim data, laboratory claim data, predictive model scores and member account balances. Method 160 further includes risk-stratifying 180 the one or more outcomes, and providing 190 customized messages based on at least one of the risk-stratified outcomes.

Member Data Compilation and Outcomes

The following provides examples of how member data may be analyzed as part of compiling member data to identify one or more outcomes, which are conclusions that may be drawn from an analysis of the member data.

Medical claims may be compiled and analyzed to determine whether the member is in compliance with evidence based medicine guidelines and/or preventative care recommendations. If the member is not in compliance, non-compliant gaps in the member's care may be identified.

Medical claims and/or health assessments may be compiled to identify member conditions and determine whether the condition is chronic or non-chronic. For example, health assessment information is analyzed using various algorithms to determine whether the member is identified as having a condition, e.g., alcoholism, alcoholic tendencies, depression and anxiety, and on whether the identified condition is chronic or non-chronic.

Health assessment information and medical diagnosis information may be analyzed to identify lifestyle risks associated with the member's lifestyle. For example, for members having a chronic condition, lifestyle risks may be identified by analyzing medical diagnoses with health assessment results in view of the member's chronic condition.

A member's utilization of prescription medication may be compiled to determine whether their benefits plan covers the costs of the identified prescription(s), and whether a generic form of the prescription is available at a lower cost. A prescription drug class may also be compared to the member's prescription and benefits plan in order to identify prescription alternatives.

A member's network usage and/or non-emergent visits to an emergency room may be compiled to determine the member's utilization efficiency.

Member account balances such as in-network and out-of-network balances, and health savings account, health retirement account, and flexible savings account balances may be retrieved and compared with a member's benefits plan to determine the balance remaining for one or more member accounts and to determine whether the member has efficiently used their accounts, or whether the funds in one or more member accounts are depleted.

Claim data and industry standard data may be used for predictive modeling to calculate a risk score associated with the member. Methods and systems for calculating risk scores are provided in U.S. patent application Ser. No. 09/635,911, filed Aug. 10, 2000, and entitled “System and Method for Modeling Healthcare Utilization,” which is incorporated herein by reference in its entirety. A risk score may also be generated using a member's compliance record and industry medical costs.

A member's prescription claim data may be compiled and compared with medical protocols related to compliance with medication adherence in order to determine whether the member is compliant with the recommended prescription treatment for their condition and/or to determine if the member is regularly refilling their prescription(s).

In addition, each of the above-described types of member data may be compiled with one or more of the other types of member data in order to yield member compliance, conditions, risks, costs, and other outcomes that may be useful for customized messages in accordance with various implementations.

Risk Stratification

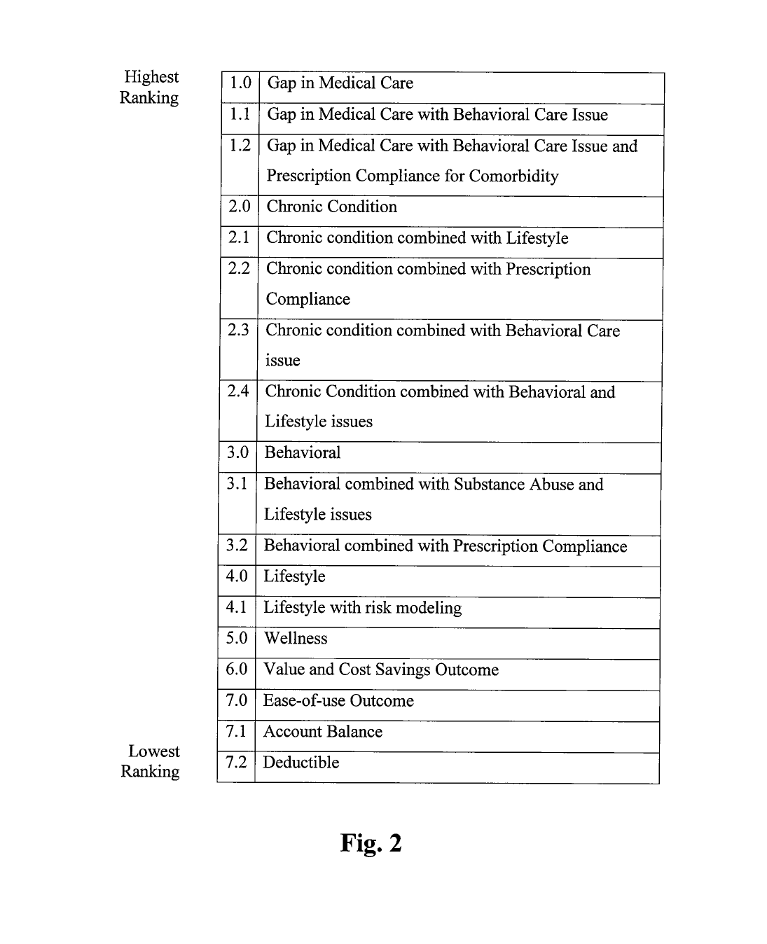

According to implementations of the present invention, the outcomes of the compilation of member data are risk-stratified. Risk-stratification involves assigning priorities to the outcomes of the compilation. FIG. 2 provides an exemplary risk stratification chart listing the types of outcomes that may result from compiling member data.

According to the exemplary risk stratification chart of FIG. 2, 1.0 represents the highest ranking and may include, for example, an outcome showing a diabetic member is not taking their insulin or any member not taking their key medications. For 1.1 (gap in medical care with behavioral care issues) a noncompliant diabetic with depression may be identified. In 1.2 (gap in medical care with behavioral care issues and prescription compliance for comorbidity) an outcome may involve identifying a diabetic with depression that is taking the wrong drugs, or who is involved in drug use or other activities that involve risk.

For the chronic condition stratification level, 2.0 -2.4 from the chart of FIG. 2, an outcome may receive a 2.0 stratification score for a chronic condition when the member has a heart condition. An outcome may receive a 2.1 stratification score (chronic condition combined with lifestyle) when the member data indicates the member has a heart condition and regularly drinks alcohol. A member-based data outcome which finds that the member having a heart condition is taking the wrong medication for their condition, not enough medication, or that is involved in prescription fraud or abuse may be assigned a stratification score of 2.2 (chronic condition combined with prescription compliance. Where an outcome results from a determination that the member having the heart condition is depressed, has anxiety or is abusing substances, the assigned stratification score may be 2.3 (chronic condition combined with behavioral care issues). A 2.4 risk stratification score (chronic condition combined with behavioral and lifestyle issues) assigned to an outcome may result when it is determined that the member with a heart condition is abusing alcohol and prescription medication and is also depressed.

For the 3.0-3.2, behavioral, stratification level from the chart of FIG. 2, an exemplary outcome that may receive a 3.0 stratification score for behavioral issues is a member who is depressed or has anxiety issues but does not have a specific condition, e.g., where the member does not have a chronic condition. Where it is determined that a member has depression and is abusing drugs and/or alcohol, an outcome that identifies these aspects of a member may receive a 3.1 stratification score (behavioral issue combined with substance abuse and lifestyle issues). For an outcome resulting from a determination that the member is depressed and is not taking their medication, a 3.2 risk stratification score (behavioral issue combined with prescription compliance) may be assigned to the outcome.

For the 4.0 (lifestyle) stratification level, an outcome may be assigned this score when it is determined that the member is making unhealthy lifestyle choices. Where an outcome takes into account that a member is making unhealthy lifestyle choices, which increases the likelihood that the member will become sick or develop a chronic illness in the future, a 4.1 risk stratification score may be assigned.

For the 5.0 (wellness) stratification level, an outcome may be assigned this stratification score when it is determined that the member is relatively healthy. An outcome showing the member is using brand name prescriptions rather than a generic form of the drug may be assigned a 6.0, value and cost savings, score. For an outcome that shows the member is inefficiently using the funds in their member accounts, a 7.0 (ease-of-use) score may be assigned. For an outcome showing that the member's health savings account is nearly depleted, a 7.1 (account balance) score may be assigned. For an outcome showing that the member is nearing their out-of-pocket maximum, a risk stratification score of 7.2 (deductible) may be assigned.

Providing Customized Messages

Whether customized messages are generated for the risk-stratified outcomes of the member data compilation may be determined by outcome rank. For example, where member data compilation results in four outcomes, one related to a chronic condition (2.0), another related to cost savings (6.0), one related to account balances (7.1) and one related to deductibles (7.2), and where one customized message is to be generated for the member, the customized message generated will be for the outcome with highest rank. In this case, the chronic condition outcome has the highest ranking, 2.0.

However, for multiple outcomes falling within the same stratification level, e.g., 2.0, for one chronic condition, and 2.4, for another chronic condition combined with behavioral and lifestyle issues, a message for the 2.4 stratification level may be provided because the outcome results from identifying member data related to additional risks, e.g., behavioral and lifestyle issues.

In a further example, where member data compilation results include multiple outcomes falling within the same ranking, and where a single customized message is to be generated, the outcomes having the same rank may be scored using a predictive model. In one example, the predictive model may score an outcome showing the member has a high propensity for an adverse medical event higher than an outcome that shows the member as having a lower propensity for an event. According to this example, a customized message may be provided corresponding to the outcome having the highest predictive model score.

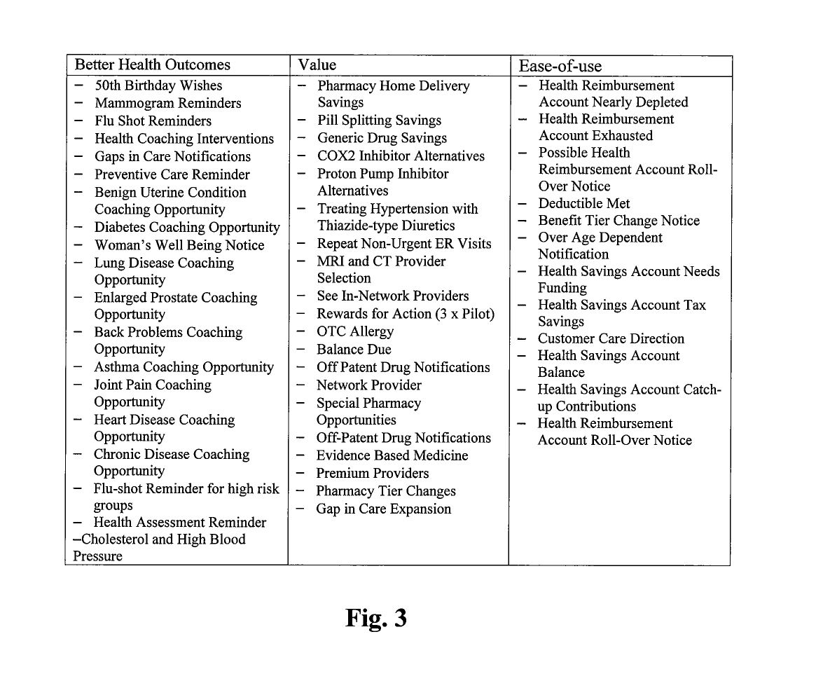

FIG. 3 provides a table of exemplary message topics that may be provided. For example, customized messages discussing better health outcomes may be clinically and plan based, such as preventative care reminders, notifications or preventative care services supported by the member's benefits plan and/or chronic condition management schedules that includes services available to the member under their benefits plan. Cost savings messages may be based on utilization, such as customized messages instructing the member about prescription and network utilization under their benefits plan. Ease-of-use messages may be financially based, and may communicate information regarding the member's health spending/savings balances and accounts. According to the various implementations, in generating customized messages, a member's benefits plan, e.g., plan design and benefit set, are taken into account so that the customized messages provided to the member reflect the terms of the member's individual healthcare plan.

The following provides examples of types of customized messages provided as a result of identifying and stratifying outcomes.

The exemplary types of customized messages below takes into account a member's benefits plan in accordance with the methods described in FIGS. 1A and 1B. Accordingly, the exemplary messages may be configured based on the member's benefits plan, or may originate from member data that takes into account a member's benefits plan.

Better Health Outcome Messages

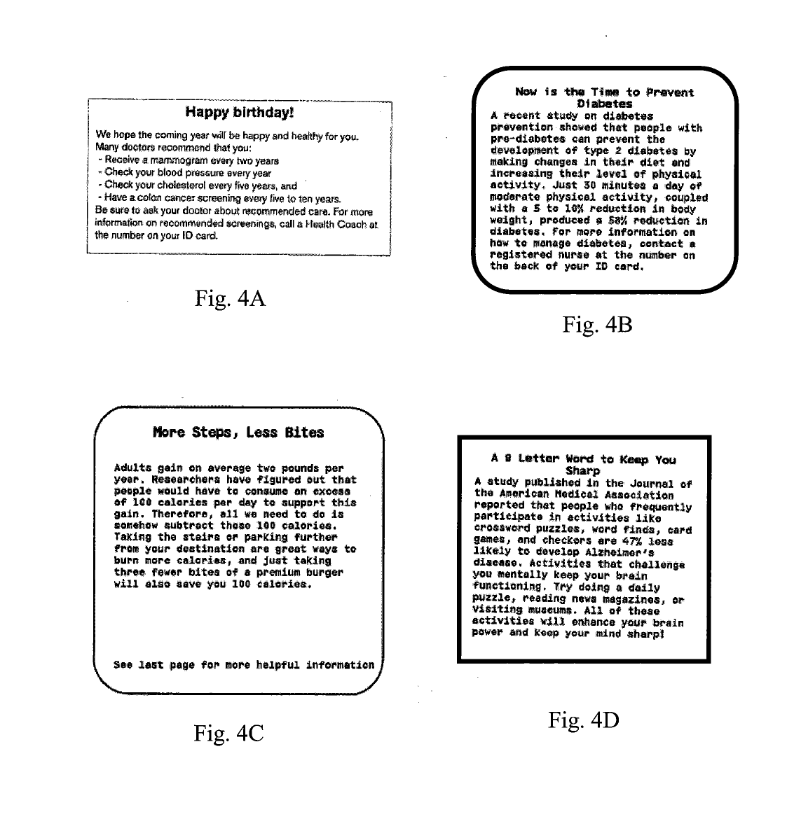

For gap in care outcomes, such as when the member's care is not aligned with the recommended evidence based medicine or preventative care guidelines, the customized message generated may notify the member of their recommended care, and in some instances, provide a listing of in-network referrals based on their benefits plan. FIG. 4A provides an exemplary customized message box for a female member who has reached age 40 that provides information on recommended care for a person her age. Where a gap in care relates to a non-chronic condition, e.g., medication noncompliance, is identified based on member data, and where plan benefits for treating the non-chronic condition are available, customized messages may direct the member to contact a health coach. Where coverage for a non-chronic condition is not available, the member may be guided towards alternative resources that may be useful in addressing their condition.

In one example, the absence of a retinal exam for a member that is diabetic is identified as a gap in care, and customized messages may notify the member that a retinal exam should be scheduled. In addition, the member's benefit information relevant to a retinal exam may also be provided in the member's customized messages, such as a referral to in-network providers and/or the type of retinal exam with the most coverage under the benefits plan. According to further embodiments, member data compilation may identify an ophthalmologist that the member has previously seen for a retinal exam, and the generated message may include contact information for the ophthalmologist identified.

In another example, where a gap in care is identified due to a member with a heart condition not taking a beta blocker, customized messages may notify the member that beta blockers are recommended for their condition and refer the member to a life coach.

In yet another example, a female member that has not received a mammogram in accordance with preventative care guidelines may receive customized messages notifying the member of her gap in care, along with information on how to receive in-network mammography services.

Moreover, and according to various embodiments, because a member's benefits plan, including plan design and benefit set, are taken into account when providing customized messages, the member may be informed on what to expect so that, for example, where a member's plan design covers 100% of preventative care, a message may remind a member they are due for a preventative care mammography, and that it is covered at 100%.

For outcomes related to a member having a chronic condition or a precursor to a condition, messages provided may inform the member of the proper protocols for managing their chronic condition and relevant services available to them, based on their benefits plan. FIG. 4B provides an exemplary customized message box that is intended to educate a pre-diabetic of actions they may take to lessen the chances they will become diabetic. In another example, where the member's plan benefit design includes services for a health coach or a registered nurse, the message may inter alia include the appropriate contact information for the health coach or registered nurse. Otherwise, where the member's plan does not cover a health coach or registered nurse, the message provided may instruct the member to contact their physician about managing their chronic condition.

For outcomes related to a member having a chronic condition and behavioral health issues, e.g., diagnosed or undiagnosed, the member may receive customized messages that provides instructions for the member to contact a nurse for addressing their chronic condition and behavioral health issues. Alternatively, messaging may be provided that gives instructions on how to address the member's chronic condition and behavioral health issues. The messages may be configured based on the members benefit plan so that an appropriate disease management nurse covered under their benefits is listed in the message. For a member with a chronic condition and behavioral health issues that does not have plan benefits that cover treatment for the member's behavioral health issues, messages may instruct the member to contact a disease management coach and direct the member towards free and/or affordable resources for addressing their behavioral health issue.

For outcomes related to a member having behavioral health issues without an identified chronic condition, a member may receive messages instructing them to contact a life coach and/or a behavioral health hotline.

For lifestyle outcomes, for example, that identify risks associated with a member's lifestyle choices, the member may be provided with a customized message educating and/or notifying the member of the risks associated with their lifestyle choices and, in some instances, instructions to contact a medical professional to discuss the member's risks, provided that the member's plan benefits include risk management services. Alternatively, where the member's plan design does not cover risk management services, messages may be directed towards educating the member about their lifestyle. FIG. 4C provides an exemplary customized message box for a member that is slightly overweight who does not have benefits related to coaching services. FIG. 4D provides an exemplary customized message box for a member that has reached the age of 65 that does not have coaching services available to them, who is no longer working. In another example, where a member does not have coverage for risk management services, customized messages may indicate that a member's lifestyle choices involves risks, along with instructions to contact a primary physician or an outside organization that may be able to provide guidance.

Value and Cost Savings Messages

For value and cost savings outcomes, messages provided may indicate that a generic form of the member's prescription is available and covered under their benefits plan. In another example, where the member's benefits plan offers mail order prescriptions, messages may be generated that directs the member to use the mail order service for cost savings related to their prescription medication costs. FIG. 4E provides an exemplary customized message box for a member that is taking Lipitor but is not utilizing mail order prescription services available to them. In further examples, where a lower cost prescription alternative within the same drug class as a member's prescription is available and covered under the member's benefits plan, messages may be generated notifying the member of the prescription alternative. In addition, a member's formulary may be compared to their prescription history in order to determine whether their current prescription(s) are on the formulary, and if not, messages may provide the member with alternate drug suggestions listed on the member's formulary.

For outcomes related to cost savings, for example, related to a member's network usage, messages may suggest that the member use in-network providers in order to realize cost savings. In some implementations, where a member's usage data indicates that the emergency room was used for non-emergent reasons, a customized message encouraging the member to use a network provider in order to realize cost savings may be provided.

Ease-of-use Messages

For outcomes related to ease-of-use, for example as a result of determining that member accounts are underutilized or inefficiently utilized, customized messages may provide tips on how to more efficiently use account funds. FIG. 4F provides an exemplary customized message for a member that has nearly exhausted the funds in their health reimbursement account, which provides notification of this matter, along with resources available to the member in order to discuss how to manage their health finances. Where an outcome relates to a member reaching their out-of-pocket maximum, customized messages may provide notification of this aspect of their healthcare program.

According to further implementations, a customized message may be generated that is related to two or more risk-stratified outcomes. For example, compilation of member data may result in outcomes involving both a gap in care along with a chronic medical condition. In this case, the message generated may notify the member of the gap in care, and information on whether their benefit plan provides coverage for the missing treatment, along with instructions on contacting an appropriate health service professional provided under their benefit plan in order to discuss their chronic medical condition.

In some implementations, in addition to a member's benefits plan, customized messages may be configured using a member's communication preferences, e.g., via a member portal and health statements or via a member portal only. Furthermore, customized messages may be configured based on consumer modeling and segmentation information in which a member's life stage, e.g., socioeconomic background and demographics, utilization and healthcare consumption information are taken into account. In addition, a member's previous response history to customized messages and their personality, e.g., determined by phone call analysis or other member encounters, may be used to configure customized messages.

According to further configurations, for outcomes in which customized messages have been previously provided, another outcome may be used as a basis for providing customized messages. Accordingly, messages the member was previously provided may be removed or filtered so that they are not presented to the member multiple times.

Alternatively, in some configurations, suitable customized messages may be a series of sequential messages. Accordingly, after a first message in a series is presented to the member, a second message in the series may be presented to the member, provided that the corresponding outcome results from compilation of member data. Thus, the series of messages may be presented to the member over a period of time, and may relate to, for example, ways for a member to manage their chronic condition in order to achieve a better health outcome.

In various configurations customized messages methods may be executed on a periodic basis. For example, methods for providing customized messages may be run daily, weekly, monthly, quarterly and/or annually. Alternatively, triggering events may result in providing customized messages. For example, triggers may include a member receiving medical services, identifying recent claims or medical assessments associated with the member, change in member status, e.g., employment status, and/or modification of a member's benefits plan, e.g., plan design and/or benefits set.

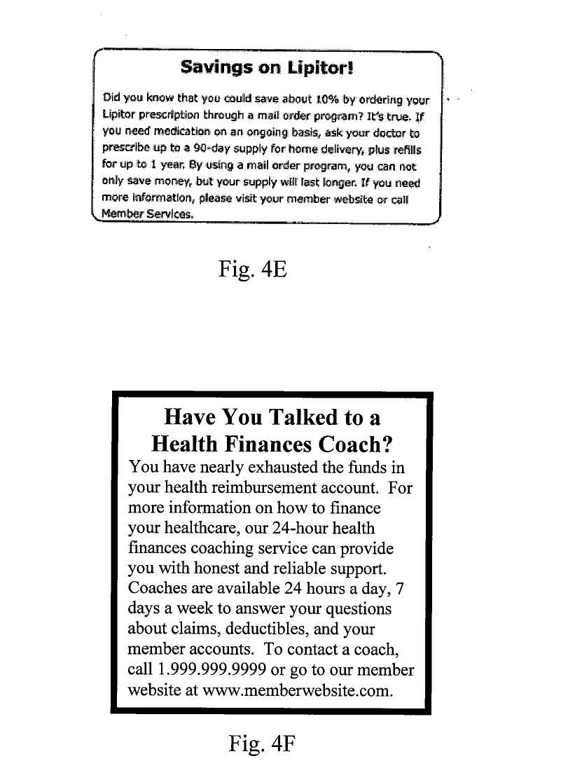

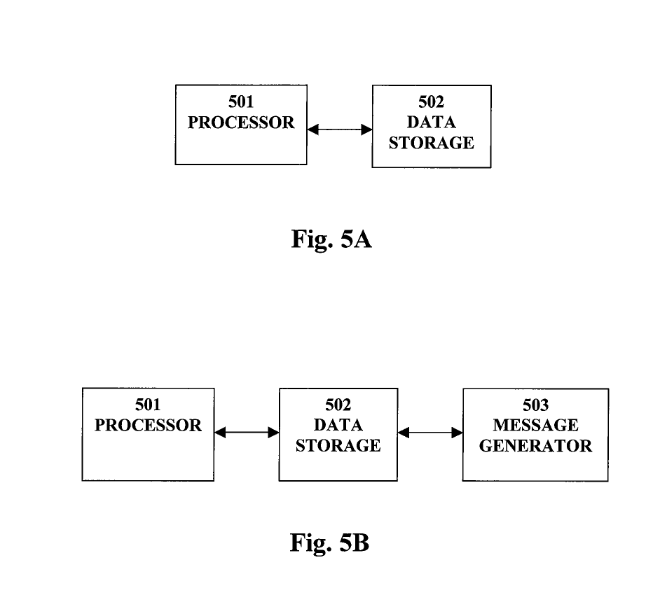

FIG. 5A is a diagram of an exemplary system for providing customized messages, e.g., a flyer, notification or health statement that includes messages that may be useful for a member in achieving effective management of their healthcare decisions. The exemplary system includes a processor 501 and data storage 502. The processor 501 is configured to receive member data from various data sources, analyze the member data, and retrieve or generate one or more customized messages associated with the member based on the information received from the various data sources. Data storage 502 is configured for storing member data and is communicatively coupled to the processor 501 to enable the processor to retrieve the member data and/or one or more customized messages.

Data storage 502, according to certain implementations, may include various data sources that provide processor 501 with member data. The data sources may include one or more databases associated with medical claims, prescription claims, laboratory claims, EBM protocols, health assessments, plan designs, benefit sets, medical balances, eligibility data, ancillary data and predictive model scores.

Customized messages that may be generated or retrieved by processor 501 may include messages directed towards achieving better health outcomes, value and/or ease-of-use. FIG. 3, described above, provides exemplary types of customized messages that may be provided, according to various implementations.

According to one configuration, and with reference to FIG. 5B, a system for providing customized messages via a member health statement includes a processor 501, data storage 502, and a health statement generator 503. Processor 501 provides the retrieved customized messages to health statement generator 503, where the customized messages are included in a member's health statement or otherwise formatted. The health statement may subsequently be provided to the member via electronic notification such as by email, text messaging, or other digital format, or in paper form, e.g., by mail. In further configurations, customized messages may be provided to the member via a member portal, e.g., a website supported by the member's insurance company, or email.

In alternative configurations, customized messages related to a member may be provided to healthcare personnel involved in the healthcare management of the plan member. Nurses, life coaches, customer care professionals (CCP) counselors, physicians and other administrators responsible for assisting members with healthcare management may all be considered healthcare personnel according to the various implementations. For example, customized messages may be provided to a CCP responsible for contacting the member, and the CCP may review the messages and instruct the member on how to achieve better health outcomes for their condition(s), for example. The member may be able to select the form in which the customized messages are received.

In certain embodiments, and as described in FIG. 5B, customized messages may be delivered to a member via health statements, which may combine into one document, customized messages, various types of healthcare-related information and financial elements relevant to the member's healthcare experience. According to some embodiments, the customized messages provided in health statements may include member-specific messages related to achieving better health outcomes, for understanding and utilizing member balances and/or for understanding value and savings options related to network providers, prescription options, for example. In addition, health statements inter alia include group/plan information, eligibility details, e.g., subscriber information and address, and member(s) information, customer service information, claim information, e.g., medical, pharmacy and financial information. Financial information may include financial information related to flexible spending accounts (FSAs), health retirement accounts (HRAs), health savings accounts (HSAs), and HIA and CAC details. In addition, health statement may include balance information, e.g., in-network and out-of-network deductible balances, and FSA, HRA, HSA and maximum lifetime coverage balances, adjustment details, e.g., adjustment details that would impact balances provided, statement specific information, e.g., standard messages, remark codes, reason codes, and financial claim information.

Health statements may be provided to the member periodically, such as every 28 days, monthly, quarterly, bi-annually, annually, when the member receives healthcare services and/or after the member has received a predetermined amount of healthcare service, e.g., by procedure and/or cost.

Alternatively, in some embodiments, health statements or notifications may be provided to a member if they have not received treatment for a diagnosed condition after a period of time. For example, where a member is diagnosed with a condition that requires periodic monitoring, and the member has not been receiving the recommended monitoring, a notification may be provided to the member that includes instructions on how and/or where to receive the recommended care for their condition. In some embodiments, where the member has not received recommended services for monitoring their condition but has received medical treatment for another purpose, a health statement may be provided that includes financial information related to the medical treatment along with messages notifying the member that they are due to receive the monitoring services identified.

According to further embodiments, messages that may be relevant to a member may be delivered via multiple communication channels, including via mail, email, a web portal, and over the phone, e.g., via a CCP, life coach and/or registered nurse.

Moreover, customized messages may be tracked for each member. Accordingly, in some configurations, the results of providing customized messages may be measured based on member behavior trends. In response, customized messages may be modified in order to achieve desired results. For example, customized messages may be modified in order to compensate for member behavior or market influences.

Customized messages may be further configured to influence member behavior by providing the member with relevant information related to health initiatives such as health fairs, a nursing hotline, member life coaching and/or other opportunities that may be useful for the member.

The method and system according to the present invention may be implemented using various combinations of software and hardware as would be apparent to those of skill in the art and as desired by the user. The present invention may be implemented in conjunction with a general purpose or dedicated computer system having a processor and memory components.

From the above description and drawings, it will be understood by those of ordinary skill in the art that the particular implementations shown and described are for purposes of illustration only and are not intended to limit the scope of the present invention. Those of ordinary skill in the art will recognize that the present invention may be embodied in other specific forms without departing from its spirit or essential characteristics. References to details of particular implementations are not intended to limit the scope of the invention.

What is claimed is:

1. A method for providing customized messages relating to a health plan member comprising:
compiling health-related member data associated with the member;
analyzing the member data to identify at least one outcome relating to the health or healthcare of the member;
risk-stratifying the at least one outcome;
generating message data based on at least one of the risk-stratified outcomes;
configuring the message data based on the member's health plan benefits; and
providing a customized message including the configured message data to the member.

2. The method of claim 1, wherein the health-related member data comprises at least one of medical, laboratory, prescription claim data, healthcare-related claim data, and health assessment data.

3. The method claim 1, wherein compiling member data comprises analyzing member data using industry standard data.

4. The method of claim 3, wherein the industry standard data comprises evidence based medicine data or industry medical cost data.

5. The method of claim 1, wherein the health-related member data comprises member plan benefit data, member claim data, prescription claim data, laboratory claim data, predictive model scores and member account balances.

6. The method of claim 1, wherein compiling member data comprises predictive modeling of health-related risks.

7. The method of claim 1, wherein risk-stratifying the one or more outcomes comprises ranking each of the one or more outcomes, and wherein the message data comprises the highest ranked outcome.

8. The method of claim 1, wherein the customized message is provided as part of the member's health plan statement.

9. The method of claim 1, wherein the customized message is provided to the member electronically.

10. The method of claim 1, further comprising configuring the message data based on the members communication preferences.

11. A method for providing customized messages relating to a health plan member comprising:
compiling health-related member data associated with the member;
analyzing the member data to identify at least one outcome relating to the health or healthcare of the member;
risk-stratifying the at least one outcome;
generating message data based on at least one of the risk-stratified outcomes;
configuring the message data based on the member's health plan benefits; and
providing a customized message including the configured message data to healthcare personnel.

12. The method of claim 11, wherein the healthcare personnel is a healthcare provider.

13. The method of claim 11, wherein the healthcare personnel is a customer care professional.

14. The method of claim 11, wherein the health-related member data comprises member plan benefit data, member claim data, prescription claim data, laboratory claim data, predictive model scores and member account balances.

15. The method of claim 11, wherein risk-stratifying the one or more outcomes comprises ranking each of the one or more outcomes, and wherein the message data comprises the highest ranked outcome.

16. A system for providing a customized message relating to a health plan member, comprising:
data storage for storing health-related member-related data;
a processor for:
compiling health-related member data associated with the member;
analyzing the member data to identify at least one outcome relating to the health or healthcare of the member;
risk-stratifying the at least one outcome;
generating message data based on at least one of the risk-stratified outcomes; and
configuring the message data based on the member's health plan benefits; and
a message generator for providing a customized message including the configured message data to the member.

17. The system of claim 16, wherein the message generator is a health statement generator for receiving the configured message data and generating a member health statement that includes the configured message data.

18. The system of claim 16, further comprising the processor configuring the message data based on the member's communication preferences.

19. A customized message for a health plan member, wherein the customized message is generated by:
compiling health-related member data associated with the member;
analyzing the member data to identify at least one outcome relating to the health or healthcare of the member;
risk-stratifying the at least one outcome;
generating message data based on at least one of the risk-stratified outcomes;
configuring the message data based on the member's health plan benefits to create a customized message.

20. The customized message according to claim 19, further comprising configuring the message data based on the member's communication preferences.
